(19) United States
(12) Patent Application Publication
(10) Pub. No.: US 2004/0013916 A1
(43) Pub. Date: Jan. 22, 2004

(54) Environment neutralization of pem bipolar plate fuel cell effluent in situ

(76) Inventors: Arvind M. Rao, Rochester, NY (US); Carolyn Deborah Fleming, Lima, NY (US)

Correspondence Address: VINCENT A. CICHOSZ, DELPHI TECHNOLOGIES, INC., Legal Staff, P.O. Box 5052, Mail Code: 480-414-420, Troy, MI, 48007-5052, US

(21) Appl. No.: 10/198,323

(22) Filed: Jul. 18, 2002

(51) Int. Cl. H01M 8/24; H01M 8/08; H01M 12/06

(52) U.S. Cl. 429/18; 429/32; 429/46; 429/27; 429/13

(57) ABSTRACT

A corrosion-resistant electrochemical device includes a plurality of fuel cells connected in electrical series, each fuel cell having a membrane-electrode-assembly comprising an anode catalyst layer and an anode diffusion layer disposed on one side of an electrolyte membrane and a cathode catalyst layer and cathode diffusion layer disposed on an opposite side of the electrolyte membrane; at least one bipolar plate disposed between adjacent fuel cells; and at least one neutralization agent or ion exchange media sufficient to neutralize corrosive species in fuel cell effluent in situ disposed within the device. The neutralization agent may be disposed in one or more locations including in flow channels of the bipolar plate, embedded within diffusion layers of the MEA, disposed in combination with the catalyst layers on the electrolyte membrane, and as an integral part of the material comprising the bipolar plate itself.

### TECHNICAL FIELD

The present invention relates to electrochemical devices and more particularly relates to the neutralization of fuel cell effluent in situ to provide a corrosion-resistant electrochemical device.

### BACKGROUND OF THE INVENTION

Fuel cells are electrochemical devices that convert chemical potential energy into usable electricity and heat without combustion as an intermediate step. Fuel cells are similar to batteries in that both produce a DC current by using an electrochemical process. Two electrodes, an anode and a cathode, are separated by an electrolyte. Like batteries, fuel cells are combined into groups, called stacks, to obtain a usable voltage and power output. Unlike batteries, however, fuel cells do not release energy stored in the cell, running down when battery energy is gone. Instead, they convert the energy typically in a hydrogen-rich fuel directly into electricity and operate as long as they are supplied with fuel and oxidant. Fuel cells emit almost none of the sulfur and nitrogen compounds released by conventional combustion of gasoline or diesel fuel, and can utilize a wide variety of fuels: natural gas, coal-derived gas, landfill gas, biogas, alcohols, gasoline, or diesel fuel oil.

Fuel cells, such as the PEM (proton exchange membrane) fuel cell, have been proposed as a power source for electric vehicles, as a secondary power source in transportation applications, and for other portable and stationary power applications. The PEM fuel cell is generally well known in the art and comprises a membrane-electrode-assembly (MEA) comprising a thin, proton-conductive polymer membrane electrolyte having an anode electrode film formed on one face thereof and a cathode electrode film formed on the opposite face thereof Hydrogen and oxygen (either pure or in air) are supplied to the anode and cathode, respectively. The PEM prevents hydrogen and oxygen from directly mixing, while allowing ionic transport to occur. At the anode, hydrogen is oxidized to produce protons. These protons migrate across the membrane, or are exchanged with other protons within the membrane, to the cathode and react with oxygen to produce water. The overall electrochemical reduction-oxidation reaction is spontaneous, releasing energy. When several PEM cells are combined in a stack, higher voltages and significant power outputs can be obtained.

The MEA for each PEM cell is sandwiched between a pair of electrically conductive elements which serve as current collectors for the anode/cathode and contain an array of grooves in the faces thereof for distributing the fuel cell's gaseous reactants (hydrogen and oxygen/air) over the surfaces of the respective anode and cathode. In a fuel cell stack, a plurality of the cells are stacked together in electrical series while being separated one from the next by an impermeable, electrically conductive contact element known as a bipolar plate. The bipolar plate serves as an electrically conductive separator element between two adjacent cells. The bipolar plate electrically conducts current between the anode of one cell to the cathode of the next adjacent cell in the stack. The bipolar plate has reactant gas distributing grooves, or flow channels, on both of its external faces, and in most cases, has internal passages therein which are defined by internal heat exchange faces and through which coolant flows to remove heat from the stack.

In the PEM fuel cell environment, the exterior faces of the bipolar plates, which confront the membrane-electrode-assembly (MEA), are in constant contact with highly corrosive, acidic fuel cell effluent solutions (having a pH of about 3.5 to about 4.5) containing fluoride (F⁻), sulfate (SO₄⁻), sulfite (SO₃⁻), hydrogen sulfate (HSO₄⁻), carbonate (CO₃⁻), and hydrogen carbonate (HCO₃⁻), etc., counterions. To survive in such a corrosive environment, at least the exterior faces of the bipolar plates must be highly corrosion resistant.

One approach to the problem of bipolar plate corrosion is to use materials having the ability to withstand the oxidizing conditions within the electrochemical cell, such as gold, titanium, niobium, and tantalum. These metals, however, are prohibitively expensive. In addition, in highly acidic applications, such as PEM fuel cell applications, these metals are subject to anodic dissolution at the cathode, hydrogen embrittlement at the anode, and the formation of electronically resistive oxide films. The art also details pellicle techniques such as use of corrosion resistant coatings that could prevent the direct attack of the metal substrate. U.S. Pat. No. RE37,284 (Reissue of U.S. Pat. No. 5,624,769) to Li et al., discloses a PEM fuel cell having electrical contact elements (including bipolar plates/septums) having a titanium nitride coated light weight metal core and a passivating, protective metal layer intermediate the core, and the titanium nitride. The protective layer forms a barrier to further oxidation or corrosion when exposed to the fuel cell's operating environment.

For electrochemical devices, such as PEM fuel cells, to become a competitive energy technology, particularly in transportation applications, the power densities and operating lifetimes of the devices must be increased and the manufacturing and operating costs reduced. What is needed in the art is a fuel cell stack that is lightweight, compact, low cost, and non-corroding. For transportation applications, PEM bipolar plate durability requirements of about 5000 operating hours are highly desirable.

### SUMMARY OF THE INVENTION

The present invention contemplates a device and method for neutralization of fuel cell effluent in situ providing a corrosion-resistant electrochemical device. The present corrosion-resistant electrochemical device comprises a plurality of individual fuel cells connected in electrical series, each fuel cell having a membrane-electrode-assembly (MEA) comprising a positive electrode, a negative electrode, and a separator that contains an electrolyte, and at least one bipolar plate disposed between adjacent individual fuel cells. A neutralization agent sufficient to neutralize corrosive species in fuel cell effluent is disposed within the electrochemical device at one or more locations.

In one embodiment, the neutralization agent is disposed in flow channels of the bipolar plate.

In an alternate embodiment, the neutralization agent is embedded within diffusion layers of the MEA.

Other locations for disposal of the neutralization agent are contemplated and constitute part of the present invention. For example, in another embodiment, the neutralization agent (or ion exchange media) may be included as an integral part of the material comprising the bipolar plate itself.

In another embodiment, the neutralization agent or ion exchange media may be combined with the catalyst layers on the membrane material. In this embodiment, a combination of neutralization agent and catalyst are disposed on the membrane material. This embodiment is particularly advantageous in that it addresses the problems associated with catalyst pooling that is known to occur on the membrane material resulting in portions of the membrane having excess catalyst and portions of the membrane being catalyst free. The combination neutralization agent or ion exchange media catalyst layer provides a substantially uniform layer with the neutralization agent or ion exchange media acting as a placeholder to prevent migration and associated clumping of catalyst.

The method for operating a corrosion-resistant electrochemical device comprises providing a plurality of individual fuel cells connected in electrical series, each fuel cell having a membrane-electrode-assembly comprising an anode catalyst layer and an anode diffusion layer disposed on one side of an electrolyte membrane and a cathode catalyst layer and cathode diffusion layer disposed on an opposite side of the electrolyte membrane; disposing at least one bipolar plate between adjacent individual fuel cells, the bipolar plate having oxygen flow channels and hydrogen flow channels; disposing a neutralization agent or ion exchange media within the electrochemical device, the neutralization agent or ion exchange media being sufficient to neutralize corrosive species present in fuel cell effluent; and operating the electrochemical device whereby corrosive species present in the fuel cell effluent are neutralized by the neutralization agent or ion exchange media in situ.

Electrochemical devices as used herein include, but are not limited to, PEM fuel cells, phosphoric acid fuel cells, alkaline fuel cells, direct methanol fuel cells, aluminum-air reserve cells and the like.

By providing environment neutralization of corrosive cell effluent within the fuel cell, the present invention eliminates the need for expensive corrosive resistant materials. Advantageously, the present invention enables the use of low cost plate materials and coatings without sacrificing performance or durability. In the present invention, environment neutralization is an advantageously robust process. Further, the present invention eliminates the need for sensitive coating processes that can result in pores and failed plates or cells. Advantageously, the neutralized cell effluent can be recirculated without requiring additional components in the system.

These and other features and advantages of the invention will be more fully understood from the following description of certain specific embodiments of the invention taken together with the accompanying drawings.

### BRIEF DESCRIPTION OF THE DRAWINGS

Referring now to the drawings, which are meant to be exemplary, not limiting, and wherein like elements are numbered alike in the several Figures:

FIG. 1 is a partially exploded schematic depiction of a PEM fuel cell stack repeating unit employing in situ neutralization in accordance with the present invention.

FIG. 2 is a graph showing environment neutralization of fuel cell effluent in accordance with the present invention.

### DESCRIPTION OF THE PREFERRED EMBODIMENT

The present corrosion-resistant electrochemical device includes a plurality of individual fuel cells connected in electrical series, each fuel cell having a membrane-electrode-assembly (MEA) comprising a positive electrode, a negative electrode, and a separator that contains an electrolyte, and at least one bipolar plate disposed between adjacent individual fuel cells. A neutralization agent or ion exchange media sufficient to neutralize corrosive species (raise the pH or decrease the electrical conductivity) in fuel cell effluent is employed to negate the corrosive environment within the electrochemical device.

The present method for neutralizing acidic, corrosive environments is not meant to be limited to any particular electrochemical device and may be employed in a variety of devices including, but not limited to, PEM fuel cells, phosphoric acid fuel cells, alkaline fuel cells, direct methanol fuel cells, aluminum-air reserve cells and the like.

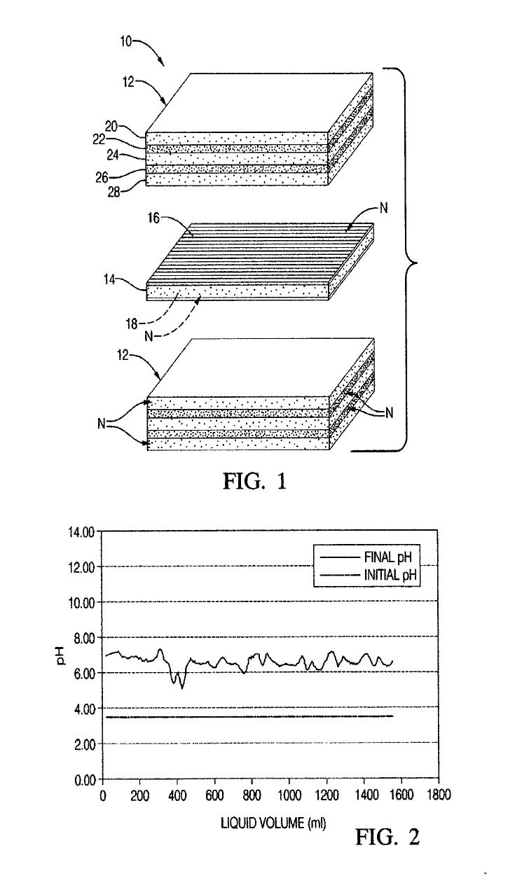

Turning now to the Figures, FIG. 1 depicts a repeating unit 10 of a PEM fuel cell stack with arrows and the letter N indicating locations for disposition of the neutralizing agent or ion exchange media in accordance with several possible embodiments of the present invention. Each repeating unit 10 includes membrane-electrode-assemblies 12 (MEA) separated by a bipolar plate 14 having oxygen flow channels 16 and hydrogen flow channels 18. (Bipolar plate coolant flowfield not shown.) Membrane electrode assemblies 12 include anode diffusion media 20 and anode catalyst layer 22 disposed on one face of electrolyte membrane 24 and cathode catalyst layer 26 and cathode diffusion media 28 disposed on the opposite face of electrolyte membrane 24.

A neutralization agent or ion exchange resin N (locations indicated by arrows in FIG. 1) is disposed within the PEM fuel cell and is selected in accordance with the particular fuel cell system requirements so as to be sufficient to neutralize corrosive species in fuel cell effluent. The selection of a given neutralization or ion exchange media is made in accordance with the cell geometry, operating conditions (temperature, pressure, humidity, etc.), nature and volume of corrosive effluent.

The neutralization agent may be disposed at any location or combination of locations within the electrochemical device sufficient to treat the fuel cell effluent. For example, in one embodiment of the present invention, the neutralization agent is embedded within diffusion layers 20, 28 of the anode and cathode, respectively, in order to treat cell effluent as it is formed.

In another embodiment, the neutralization agent is disposed within oxygen and hydrogen flow channels 16, 18, respectively, of the bipolar plate 14. Preferably, the neutralization agent is disposed along the bottom of the flow channels to provide a thin layer of neutralization agent along the flow channels 16, 18. By thin layer, it is meant that the layer of neutralization agent or ion exchange media be sufficiently thin to avoid disruption of flow through the oxygen and hydrogen flow channels 16, 18.

In yet another embodiment, the neutralization agent is disposed within the bipolar plate 14 itself by comprising an integral part of the material comprising the bipolar plate. It is currently known to construct the bipolar plate from a material comprising vinyl ester doped with about 80% graphite. In the present embodiment, the bipolar plate comprises a base material doped with a combination of graphite and ion exchange media. For example, in one possible embodiment, the bipolar plate is constructed with a vinyl ester doped with about 70% graphite and about 10% ion exchange media.

In yet another embodiment, the neutralization agent or ion exchange media N is disposed within the catalyst layers 22, 26 on the membrane material 24. In this embodiment, a combination of neutralization agent N and catalyst are disposed on the membrane material.

The neutralization agent or ion exchange media N may be any agent sufficient to neutralize the fuel cell effluent so as to substantially reduce or substantially eliminate the corrosive nature of the fuel cell environment, thus providing longevity for device elements such as bipolar plates 14, etc. The reduction or elimination of the acidic moieties in the membrane effluent is effected by (i) absorption of the ionic species, (ii) deionization, or (iii) ion exchange of the harmful ionic species for harmless ionic species in the fuel cell environment.

Absorptive techniques include the use of microporous zeolites (molecular sieves), activated carbon or clays. These are effective in removing specific moieties from the effluent, requiring the use of one or more methods and appropriate pore sizes to eliminate the acidic species.

Deionization of the effluent stream, aided by the use of cationic, anionic or mix-bed media, is accomplished by exchanging both the acidic cation or anion. Cationic exchange media include, but are not limited to, (i) natural and synthetic zeolites, (ii) acrylic acid, (iii) methacrylic acid and (iv) styrenic (sulfonic acid). Anionic exchange media include, but are not limited to, (i) styrenic (tertiary or quaternary ammonium base), (ii) acrylic (tertiary or quaternary ammonium base), (iii) aliphatic epoxy and (iv) phenol-formaldehyde epoxy.

To elucidate the neutralization capability of the present invention, a test solution simulating the concentrations of effluent species typically found in situ in an operating PEM fuel cell was prepared. To prepare the representative test solution, effluent was collected at several points in time from an operating PEM fuel cell stack built with machined graphite plates and analyzed. The machined graphite plates are significant because they are inert in the acidic effluent and therefore do not alter the effluent by reacting with it chemically. The collected effluent was analyzed using ion chromatography to determine ion content. The concentration of the two acids present were determined to be 1×10⁻⁵ M (molar) H₂SO_{4 and} 1×10⁻⁴ M HF. The pH of the effluent was 4 (as determined using a Fisher Scientific accumet Research Model AR50 dual channel pH/Ion/Conductivity meter).

A test solution was then prepared by combining ASTM D1193 type 1A de-ionized water with sulfuric acid (H₂SO₄) and hydrofluoric acid (HF) added in calculated volumes to produce a 1×10⁻⁵ M (molar) H₂SO₄ and 1×10⁻⁴ M HF test solution having a pH of about 4.

The volume of effluent produced by a single PEM cell over a lifetime [about 10,000 operating hours] was calculated separately for both the anode and cathode sides of a single cell and determined to be about 1560 milliliters (mL) maximum in total. The volume of ion exchange media that could physically fit in the single cell was determined to be about 52 cubic centimeters. (Ion resin exchange media used in this example is found in Bamstead International Corporation's High Capacity DI water cartridge Model Number D0803.) 1560 milliliters of prepared test solution was then pored over the 52 cubic centimeter bed of ion exchange media at the rate of 10 milliliters per minute. 24 millimeter batches of test effluent solution were processed through the same 52 cubic centimeter bed of ion exchange media (the media bed was not refreshed or altered). The pH of each 24 milliliter batch of test effluent solution was measured after each batch was processed. Table 1 details the characterization of the test solution.

TABLE 1

| Final pH | Liquid Volume (mL) |
|---|---|
| 6.89 | 24 |
| 7.02 | 48 |
| 7.12 | 72 |
| 7.05 | 96 |
| 6.85 | 120 |
| 6.85 | 144 |
| 6.89 | 168 |
| 6.89 | 192 |
| 6.67 | 216 |
| 6.69 | 240 |
| 6.64 | 264 |
| 6.86 | 288 |
| 7.31 | 336 |
| 6.65 | 312 |
| 6.35 | 360 |
| 5.33 | 384 |
| 5.96 | 408 |
| 5.00 | 432 |
| 6.31 | 456 |
| 6.73 | 480 |
| 6.53 | 504 |
| 6.44 | 528 |
| 6.46 | 552 |
| 6.49 | 576 |
| 6.19 | 600 |
| 6.52 | 624 |
| 6.83 | 648 |
| 6.57 | 672 |
| 6.42 | 696 |
| 6.40 | 720 |
| 6.18 | 744 |
| 5.86 | 768 |
| 6.71 | 792 |
| 6.81 | 816 |
| 6.98 | 840 |
| 6.35 | 864 |
| 6.91 | 888 |
| 6.64 | 912 |
| 6.41 | 936 |
| 6.30 | 960 |
| 6.35 | 984 |
| 6.33 | 1008 |
| 6.28 | 1032 |
| 6.46 | 1056 |
| 6.81 | 1080 |
| 5.98 | 1104 |
| 6.50 | 1128 |
| 6.11 | 1152 |
| 6.05 | 1176 |
| 6.46 | 1200 |
| 6.90 | 1224 |
| 6.97 | 1248 |
| 6.20 | 1272 |
| 6.74 | 1296 |
| 6.52 | 1320 |
| 6.42 | 1344 |
| 6.35 | 1368 |
| 6.56 | 1392 |
| 6.91 | 1416 |
| 6.74 | 1440 |
| 6.12 | 1464 |
| 6.73 | 1488 |
| 6.36 | 1512 |
| 6.20 | 1536 |
| 6.44 | 1560 |

As shown in the graph of FIG. 2, the ion exchange neutralized the test solution to a non-acidic condition (that is, a pH of about 6 to about 7).

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A corrosion-resistant electrochemical device comprising:
a plurality of individual fuel cells connected in electrical series, each fuel cell having a membrane-electrode-assembly comprising an anode catalyst layer and an anode diffusion layer disposed on one side of an electrolyte membrane and a cathode catalyst layer and cathode diffusion layer disposed on an opposite side of said electrolyte membrane;
at least one bipolar plate disposed between adjacent individual fuel cells, said bipolar plate having oxygen flow channels and hydrogen flow channels; and
a neutralization agent or ion exchange media disposed within said electrochemical device, said neutralization agent or ion exchange media being sufficient to neutralize corrosive species in fuel cell effluent in situ.

2. The electrochemical device of claim 1, wherein said neutralization agent or ion exchange media is disposed within said flow channels of said bipolar plate.

3. The electrochemical device of claim 1, wherein said neutralization agent or ion exchange media is disposed within said anode and cathode diffusion layers.

4. The electrochemical device of claim 1, wherein said neutralization agent or ion exchange media comprises an integral part of said bipolar plate.

5. The electrochemical device of claim 1, wherein said neutralization agent or ion exchange media is disposed in combination with said anode catalyst layer on one side of said electrolyte membrane and in combination with said cathode catalyst layer on an opposite side of said electrolyte membrane.

6. The electrochemical device of claim 1, wherein said neutralization agent or ion exchange media effects absorption of ionic species in said fuel cell effluent.

7. The electrochemical device of claim 6, wherein said neutralization agent or ion exchange media is selected from the group consisting of molecular sieves, microporous zeolites, activated carbon, and clays.

8. The electrochemical device of claim 1, wherein said neutralization agent or ion exchange media effects deionization of ionic species in said fuel cell effluent.

9. The electrochemical device of claim 8, wherein said neutralization agent or ion exchange media is selected from the group consisting of cationic exchange media, anionic exchange media, and mixed-bed media.

10. The electrochemical device of claim 9, wherein said cationic exchange media is selected from the group consisting of natural zeolites, synthetic zeolites, acrylic acid, methacrylic acid and styrenic (sulfonic acid).

11. The electrochemical device of claim 9, wherein said anionic exchange media is selected from the group consisting of tertiary styrenic, quaternary ammonium base styrenic, tertiary acrylic, quaternary ammonium base acrylic, aliphatic epoxy and phenol-formaldehyde epoxy.

12. The electrochemical device of claim 1, wherein said individual fuel cells are proton exchange membrane fuel cells.

13. The electrochemical device of claim 1, wherein said individual fuel cells are phosphoric acid fuel cells, alkaline fuel cells, direct methanol fuel cells, or aluminum-air reserve cells.

14. A method for operating a corrosion-resistant electrochemical device comprising:
providing a plurality of individual fuel cells connected in electrical series, each fuel cell having a membrane-electrode-assembly comprising an anode catalyst layer and an anode diffusion layer disposed on one side of an electrolyte membrane and a cathode catalyst layer and cathode diffusion layer disposed on an opposite side of said electrolyte membrane;
disposing at least one bipolar plate between adjacent individual fuel cells, said bipolar plate having oxygen flow channels and hydrogen flow channels;
disposing a neutralization agent or ion exchange media within said electrochemical device, said neutralization agent or ion exchange media being sufficient to neutralize corrosive species present in fuel cell effluent; and
operating said electrochemical device whereby corrosive species present in said fuel cell effluent are neutralized by said neutralization agent or ion exchange media in situ.

15. The method of claim 14, further comprising:
disposing said neutralization agent or ion exchange media within said flow channels of said bipolar plate.

16. The method of claim 14, further comprising:
disposing said neutralization agent or ion exchange media within said anode and cathode diffusion layers.

17. The method of claim 14, further comprising:
disposing said neutralization agent or ion exchange media within said bipolar plate so that said neutralization agent or ion exchange media comprises an integral part of said bipolar plate.

18. The method of claim 14, further comprising:
disposing said neutralization agent or ion exchange media in combination with said anode catalyst layer on one side of said electrolyte membrane;
and disposing said neutralization agent or ion exchange media in combination with said cathode catalyst layer on an opposite side of said electrolyte membrane.

19. The method of claim 14 wherein said neutralization agent or ion exchange media effects absorption of ionic species in said fuel cell effluent.

20. The method of claim 14, wherein said neutralization agent or ion exchange media is selected from the group consisting of molecular sieves, microporous zeolites, activated carbon, and clays.

21. The method of claim 14, wherein said neutralization agent or ion exchange media effects deionization of ionic species in said fuel cell effluent.

22. The method of claim 14, wherein said neutralization agent or ion exchange media is selected from the group consisting of cationic exchange media, anionic exchange media, and mixed-bed media.

23. The method of claim 22, wherein said cationic exchange media is selected from the group consisting of natural zeolites, synthetic zeolites, acrylic acid, methacrylic acid and styrenic (sulfonic acid).

24. The method of claim 22, wherein said anionic exchange media is selected from the group consisting of tertiary styrenic, quaternary ammonium base styrenic, tertiary acrylic, quaternary ammonium base acrylic, aliphatic epoxy and phenol-formaldehyde epoxy.

25. The method of claim 14, wherein said individual fuel cells are proton exchange membrane fuel cells.

26. The method of claim 14, wherein said individual fuel cells are phosphoric acid fuel cells, alkaline fuel cells, direct methanol fuel cells, aluminum-air reserve cells.
